(19) United States
(12) Patent Application Publication
(10) Pub. No.: US 2015/0370504 A1
(43) Pub. Date: Dec. 24, 2015

(54) STORAGE DEVICE CONTROL SYSTEM AND STORAGE DEVICE CONTROL APPARATUS

(71) Applicant: KABUSHIKI KAISHA TOSHIBA, Tokyo (JP)

(72) Inventor: Kensaku Yamaguchi, Kawasaki (JP)

(21) Appl. No.: 14/831,919

(22) Filed: Aug. 21, 2015

Related U.S. Application Data
(63) Continuation of application No. PCT/JP2013/074430, filed on Sep. 10, 2013.

(30) Foreign Application Priority Data
Mar. 29, 2013 (JP) 2013-074957

(51) Int. Cl. G06F 3/06

(52) U.S. Cl. CPC G06F 3/0635; G06F 3/061; G06F 3/0689

(57) ABSTRACT

According to an embodiment, a storage device control apparatus manages a plurality of storage devices. The storage device control apparatus includes a communication unit and an access controller. The communication unit is configured to receive a first storage device number and a first storage device stripe number. The first storage device number and the first storage device stripe number are obtained by an external host computer from a result of division performed by the external host computer on the basis of a stripe number and the number of storage devices. The access controller is configured to access a location identified by the first storage device stripe number in a first storage device identified by the first storage device number.

### CROSS-REFERENCE TO RELATED APPLICATION

This application is a continuation of PCT international Application Ser. No. PCT/JP2013/074430, filed on Sep. 10, 2013 which designates the United States, incorporated herein by reference, and which claims the benefit of priority from Japanese Patent Application No. 2013-074957, filed on Mar. 29, 2013; the entire contents of which are incorporated herein by reference.

### FIELD

Embodiments described herein relate generally to a storage device control system and a storage device control apparatus.

### BACKGROUND

Redundant arrays of inexpensive disks (RAID) are known as a technique that can treat a plurality of disk devices as a single storage device as a whole.

A system that achieves RAID includes a disk array provided with a plurality of disk devices, a disk array control apparatus that manages, the multiple disk devices as a single storage device, and a host computer (e.g., a CPU) that accesses the disk array via the disk array control apparatus.

Conventionally, when accessing the disk array, the host computer designates a stripe number that indicates a location in the disk array. The disk array control apparatus, then, identifies a disk device to be accessed out of the multiple disks and a disk stripe number that indicates a location in the disk device on the basis of the stripe number designated by the host computer, and accesses the identified disk device and the identified disk stripe number.

The disk array control apparatus needs to perform division so as to obtain the disk device and the disk stripe number from the stripe number.

The disk array control apparatus is often constructed from a logic circuit. The logic circuit used for division requires a large circuit size and also causes processing delay. A field programmable gate array (FPGA), which is one of the logic circuits, is often not provided with a circuit for division.

### BRIEF DESCRIPTION OF THE DRAWINGS

FIG. 1 is a schematic diagram illustrating a schematic structure of a system according to a first embodiment.

FIG. 2 is a block diagram illustrating details of the system in FIG. 1.

FIG. 3 is a flowchart illustrating operation of a host computer 101 in FIG. 1.

FIG. 4 is a schematic diagram illustrating a relation among a stripe number, a disk stripe number, and a disk number in the first embodiment and a second embodiment.

FIG. 5 is a flowchart illustrating operation of a disk array control apparatus 102 in FIG. 1.

FIG. 6 is a schematic diagram illustrating a relation among the stripe number, the disk stripe number, and the disk number in a modification of the second embodiment.

FIG. 7 is a block diagram illustrating a structure of a system according to the second embodiment.

FIG. 8 is a flowchart illustrating operation of the host computer 101 in FIG. 7.

FIG. 9 is a flowchart illustrating operation of a disk array control apparatus 700 in FIG. 7.

FIG. 10 is a flowchart illustrating operation of a second calculation unit 702 of the disk array control apparatus 700.

FIG. 11 is a block diagram illustrating a structure of a system according to a third embodiment.

FIG. 12 is a schematic diagram illustrating a relation among the stripe number, the disk stripe number, and the disk number in the system in the third embodiment.

FIG. 13 is a schematic diagram illustrating a relation among the stripe number, the disk stripe number, and the disk number in a first modification of the third embodiment.

FIG. 14 is a schematic diagram illustrating a relation among the stripe number, the disk stripe number, and the disk number in a second modification of the third embodiment.

### DETAILED DESCRIPTION

According to an embodiment, a storage device control apparatus manages a plurality of storage devices. The storage device control apparatus includes a communication unit and an access controller. The communication unit is configured to receive a first storage device number and a first storage device stripe number. The first storage device number and the first storage device stripe number are obtained by an external host computer from a result of division performed by the external host computer on the basis of a stripe number and the number of storage devices. The access controller is configured to access a location identified by the first storage device stripe number in a first storage device identified by the first storage device number.

The following describes embodiments of the present invention with reference to the accompanying drawings. In the respective drawings, the same components are labeled with the same numerals, and duplicated descriptions thereof are omitted.

### First Embodiment

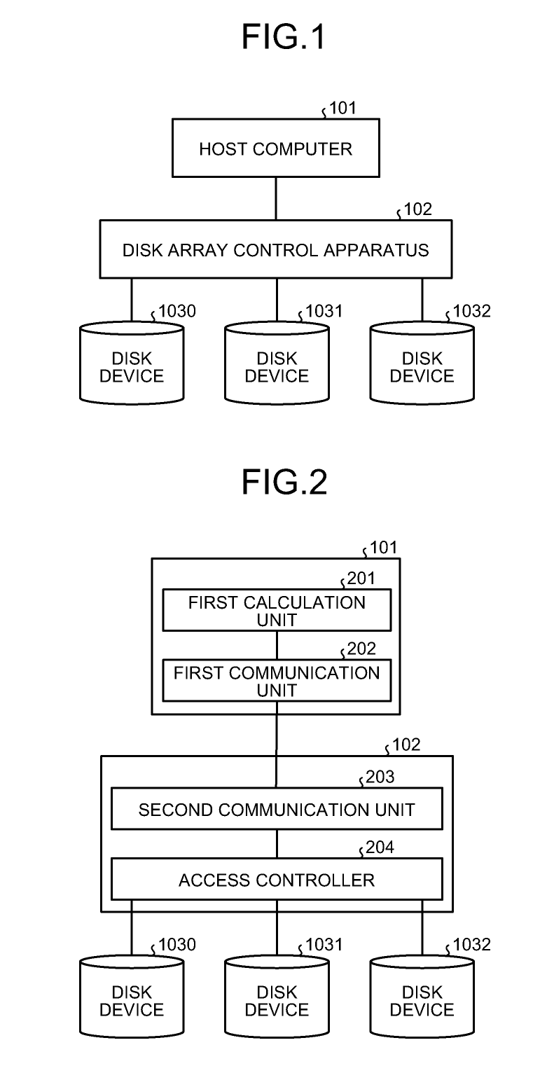

FIG. 1 is a block diagram illustrating a schematic structure of a system according to a first embodiment.

The system illustrated in FIG. 1 includes a host computer 101, a disk array control apparatus 102, and disk devices 1030, 1031, and 1032. The host computer 101 and the disk array control apparatus 102 are connected with PCI Express, for example. The disk array control apparatus 102 and the respective disk devices 1030 to 1032 are connected with serial ATA or serial attached SCSI (SAS), for example. The disk array control apparatus 102 may be provided with a plurality of ports and the respective ports may be connected to the corresponding disk devices 1030 to 1032. The disk array control apparatus 102 may be provided with a single port and the port may be connected to the respective disk devices 1030 to 1032 via a switch.

The host computer 101 is an apparatus that includes a processor and a main memory, for example.

The disk array control apparatus 102 is achieved by a logic circuit, for example. The disk array control apparatus 102 can be achieved by, particularly, a field programmable gate array (FPGA), for example. The disk array control apparatus 102 may be achieved by a processor and a main memory that differ from those included in the host computer 101.

In the embodiment, the disk devices 1030 to 1032 are exemplarily described. The devices may not be necessarily limited to disk devices such as hard disk drives (HDDs). The devices may be storage media having no disks such as solid state drives (SSDs). Any storage devices are applicable to the disk devices 1030 to 1032.

The following describes details of the system in FIG. 1 with reference to FIG. 2.

The host computer 101 includes a first calculation unit 201 and a first communication unit 202.

The first calculation unit 201 performs division on the basis of a stripe number and the number of disk devices, and obtains, using the result of the division, a first disk number that indicates a disk device to be accessed and a first disk stripe number that indicates a stripe number to be accessed in the disk device to be accessed. A method for calculating the first disk number and the first disk stripe number will be described later. The host computer 101 may grasp the number of disk devices preliminarily or may receive it notified by a second communication unit 203 of the disk array control apparatus 102.

The first communication unit 202 transmits the first disk number and the first disk stripe number to the disk array control apparatus 102.

The disk array control apparatus 102 includes the second communication unit 203 and an access controller 204.

The second communication unit 203 receives the first disk number and the first disk stripe number. As described above, the second communication unit 203 may notify the host computer 101 of the number of disk devices.

The access controller 204 accesses a location identified by the first disk stripe number in a disk device identified by the first disk number.

Disk numbers that identify the respective disk devices are provided to the disk devices 1030 to 1032. The disk stripe numbers that are information indicating the same address range in the respective storage devices are allocated to the disk devices 1030 to 1032. The address range indicated by the same disk stripe number in the disk devices 1030 to 1032 is the same address range. The address range indicated by the same disk stripe number in the disk devices 1030 to 1032 is not necessarily the same address range. Even if the disk stripe numbers, which are the same in the disk devices 1030 to 1032, correspond to different addresses from one another, the widths of the addresses corresponding to one another may be the same.

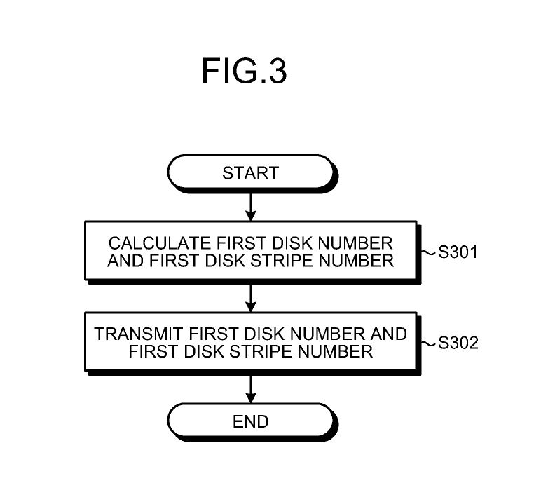

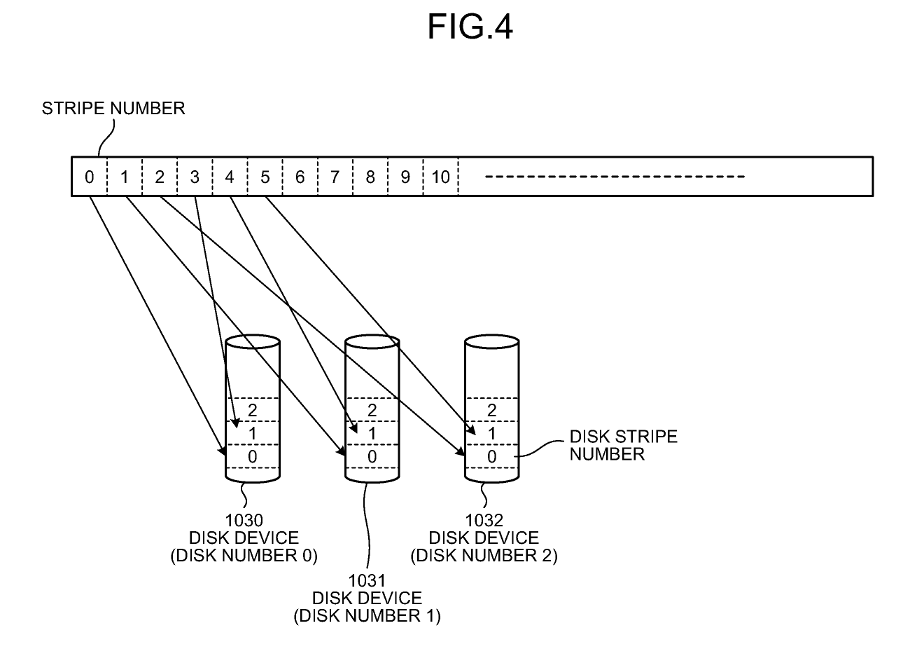

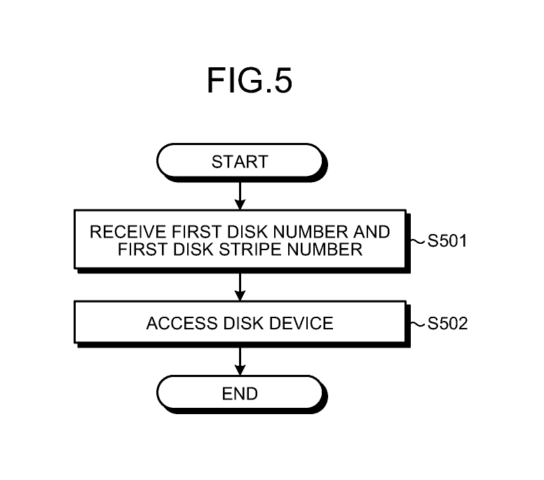

The following describes operation of the host computer 101 and the disk array control apparatus 102 in the first embodiment with reference to FIGS. 3 to 5. FIG. 3 is a flowchart illustrating the operation of the host computer 101. FIG. 4 is a schematic diagram illustrating a relation among the stripe number, the disk number, and the disk stripe number in the first embodiment. FIG. 5 is a flowchart illustrating the operation of the disk array control apparatus 102.

As illustrated in FIG. 3, the host computer 101 obtains the first disk number and the first disk stripe number on the basis of the stripe number and the number of disk devices 1030, 1031, and 1032 (step S301). At step S301, the first calculation unit 201 of the host computer 101 calculates the first disk number using expression (1), for example. The first calculation unit 201 also calculates the disk stripe number using expression (2), for example. In expression (1), mod operator represents the remainder of the division of the stripe number by the number of disk devices.

First disk number=stripe number mod number of disk devices (1)

First disk stripe number=[stripe number/number of disk devices] (2)

where [ ] represents the floor function and [X] is defined as the greatest integer equal to or less than real number X.

With reference to FIG. 4, an example is described in which the first disk number and the first disk stripe number are calculated from the stripe number and the number of disk devices using expressions (1) and (2). In the example of FIG. 4, the number of disk devices is three.

As illustrated in FIG. 4, a relation among the stripe number, the first disk number, and the first disk stripe number can be calculated as expressed in expression (3), for example, using expressions (1) and (2).

(stripe number, first disk number, first disk stripe number)=(0,0,0),(1,1,0), (2,2,0),(3,0,1),(4,1,1),(5,2,1) (3)

The host computer 101 transmits the first disk number and the first disk stripe number that are obtained at step S301 to the disk array control apparatus 102, and performs an instruction of disk access (step S302). When a plurality of sets of first disk number and first disk stripe number are obtained from a plurality of stripe numbers, the host computer 101 transmits the multiple sets of first disk number and first disk stripe number.

The following describes the operation of the disk array control apparatus 102 with reference to FIG. 5.

The second communication unit 203 receives, from the host computer 101, the first disk number and the first disk stripe number (step S501). The access controller 204, then, accesses the address identified by the first disk stripe number in the disk device identified by the first disk number out of the disk devices 1030 to 1032 (step S502). When receiving multiple sets of first disk number and first disk stripe number, the access controller 204 accesses, for each set, the address identified by the first disk stripe number in the disk device identified by the first disk number.

In the example described above, the stripe number starts from zero. The stripe number is, however, not limited to this example. For example, the stripe number may start from three.

As described above, the host computer 101 performs division to calculate the first disk number and the first disk stripe number from the stripe number instead of the disk array control apparatus 102, in the host computer 101 and the disk array control apparatus 102 according to the first embodiment. As a result, the circuit size of the disk array control apparatus 102 can be reduced. In addition, the system has an effect of being capable of achieving the disk array control apparatus 102 using an FPGA not provided with a circuit for division when the FPGA is used as a logic circuit.

### Modification

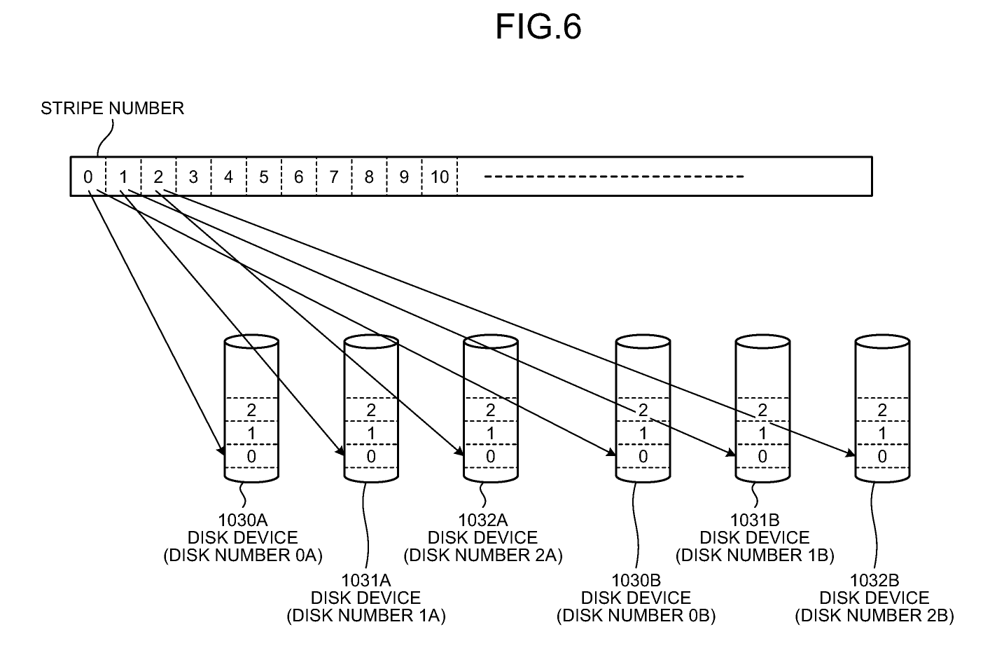

FIG. 6 is a schematic diagram explaining a modification of the embodiment.

FIG. 6 illustrates an example where the system is applied to a technique (called RAID1) to write exactly the same data into two devices.

In the example of FIG. 6, the same data is written into each of the following two devices: disk devices 1030A and 1030B, disk devices 1031A and 1031B, and disk devices 1032A and 1032B.

In this case, both of the first disk number and the first disk stripe number can be calculated using the results by assigning a value of division of the number of devices by two to the number of disk devices in expressions (1) and (2).

### Second Embodiment

The following describes a second embodiment.

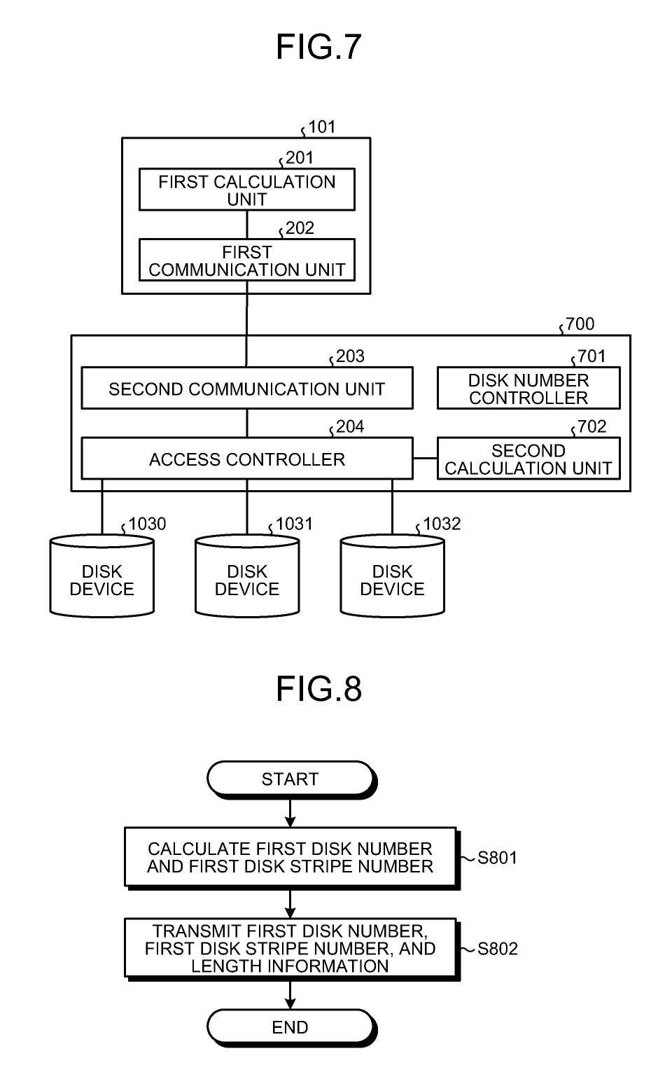

FIG. 7 is a block diagram illustrating a disk array system according to the second embodiment.

The system in FIG. 7 differs from the system in FIG. 2 in that a disk array control apparatus 700 differs in structure from the disk array control apparatus 102.

The first communication unit 202 of the host computer 101 transmits, to the disk array control apparatus 700, length information together with the first disk number and the first disk stripe number. In this case, the host computer 101 may calculate the first disk number and the first disk stripe number from the head stripe number (e.g., stripe number 0) in the example in FIG. 4, for example, and may transmit, to the disk array control apparatus 700, by adding the length information indicating a desired access length (e.g., the number of stripe numbers or the number of bytes) to the calculation result.

The disk array control apparatus 700 further includes a disk number controller 701 and a second calculation unit 702 in addition to the structure of the disk array control apparatus 102.

The second communication unit 203 receives the length information together with the first disk number and the first disk stripe number.

Until a sum of the lengths from the first disk stripe number to an Nth disk stripe number (N is an integer equal to or larger than 2) is equal to or larger than a length designated by the length information, the second calculation unit 702 calculates an (i+1)th storage device number (i is an integer between 1 and (N−1), both inclusive) and an (i+1)th storage device stripe number on the basis of an ith disk number and an ith disk stripe number. The specific calculation method will be described later. For example, the second calculation unit 702 calculates a second disk number and a second disk stripe number on the basis of the first disk number and the first disk stripe number. When the number obtained by adding one to the first disk number is an available storage device number determined by the number of disk devices (e.g., a maximum disk number determined in accordance with the number of disk devices), the second calculation unit 702 calculates the number obtained by adding one to the first disk number as the second disk number, and calculates, as the second disk stripe number, the same number as the first disk stripe number. In contrast, when the number obtained by adding one to the first disk number is not an available storage device number, the second calculation unit 702 calculates the smallest disk number out of the disk numbers of the disk devices as the second disk stripe number, and calculates the number obtained by adding one to the first disk stripe number as the second disk stripe number.

After the access controller 204 accesses a location identified by the ith disk stripe number in a disk identified by the ith disk number, the disk number controller 701 updates the ith disk number to the (i+1)th disk number, and the ith disk stripe number to the (i+1)th disk stripe number. For example, after the access controller 204 accesses the location identified by the first disk stripe number in the first disk device identified by the first disk number, the disk number controller 701 updates the first disk number to the second disk number, and the first disk stripe number to the second disk stripe number.

After the updates by the disk number controller 701, the access controller 204 accesses a location identified by the (i+1)th disk stripe number in an (i+1)th disk identified by the (i+1)th disk number. For example, after the updates by the disk number controller 701, the access controller 204 accesses the location identified by the second storage device stripe number in the second disk device identified by the second disk number.

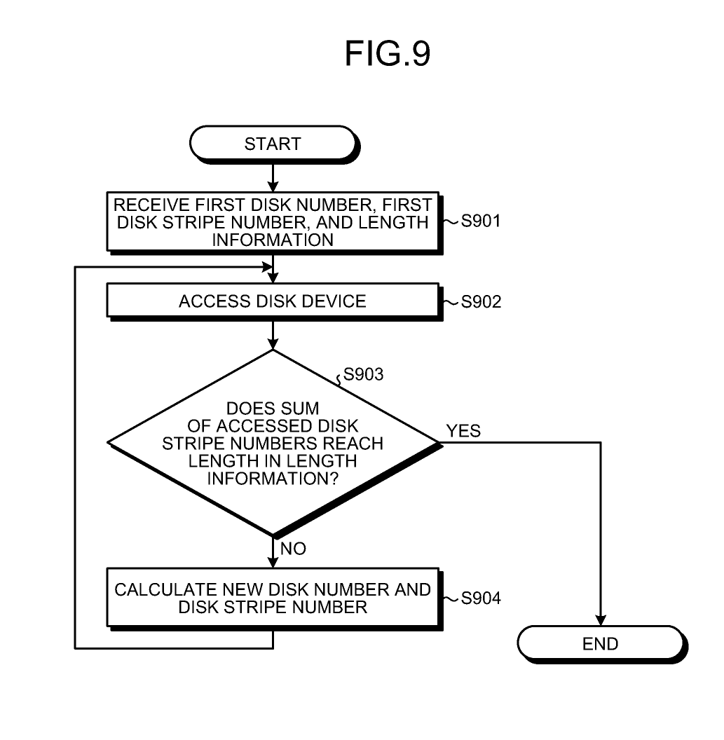

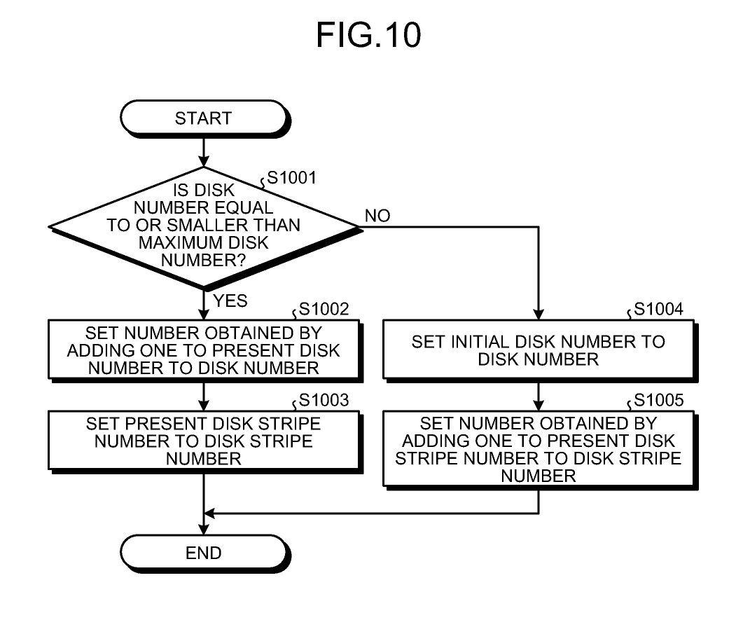

The following describes operation of the host computer 101 and the disk array control apparatus 700 according to the second embodiment. FIG. 8 is a flowchart illustrating the operation of the host computer 101 according to the second embodiment. FIG. 9 is a flowchart illustrating the operation of the disk array control apparatus 700 according to the second embodiment. FIG. 10 is a flowchart illustrating the details of the operation of the second calculation unit 702 in the disk array control apparatus 700 according to the second embodiment. In the embodiment, the stripe number, the disk number, and the disk stripe number are explained with reference to FIG. 4.

The following describes the operation of the host computer 101 with reference to FIG. 8.

The first calculation unit 201 of the host computer 101 performs division on the basis of the stripe number and the number of disk devices 1030 to 1032 to obtain the first disk number and the first disk stripe number (step S801). The first disk number can be calculated on the basis of expression (1) while the first disk stripe number can be calculated on the basis of expression (2), for example. For example, the first disk number is obtained as zero and the first disk stripe number is obtained as zero from the stripe number zero. In the embodiment, the host computer 101 obtains one set of the first disk number and the first disk stripe number from a single stripe number.

The host computer 101, then, transmits the first disk number and the first disk stripe number that are calculated at step S801 and the length information to the disk array control apparatus 700, and performs an instruction of disk access (step S802). The length information indicates the length that corresponds to six stripe numbers, for example.

The following describes the operation of the disk array control apparatus 700 according to the second embodiment with reference to FIGS. 9 and 10.

The second communication unit 203 receives, from the host computer 101, the first disk number, the first disk stripe number, and the length information (step S901). The access controller 204, then, accesses the address identified by the first disk stripe number in the disk device identified by the first disk number out of the disk devices 1030 to 1032 (step S902).

After the completion of the disk access at step S902, the disk number controller 701 determines whether the total length of the stripe numbers in disk access reaches the length indicated by the length information instructed from the host computer 101 (step S903). If the total length reaches the instructed length, the disk number controller 701 ends the processing. If the total length does not reach the instructed length, the disk number controller 701 replaces the first disk number and the first disk stripe number with the second disk number and the second disk stripe number, respectively, that are calculated by the second calculation unit 702 (step S904). The access controller 204 performs the processing at step S902 in accordance with the replaced disk number and disk stripe number. The processing is repeated from step S902 to step S904.

The following describes the operation of the second calculation unit 702 with reference to FIG. 10. The following describes an example where the second disk number and the second disk stripe number are obtained from the first disk number and the first disk stripe number. The description is applicable to processing in general to obtain an ith disk number and an ith disk stripe number from an (i −1)th disk number and an (i−1)th disk stripe number.

The second calculation unit 702 determines whether the number obtained by adding one to the first disk number is equal to or smaller than the maximum disk number (step S1001). If it is determined that the number is equal to or smaller than the maximum disk number at step S1001, the second calculation unit 702 sets the number obtained by adding one to the first disk number to the second disk number, which is the next disk number (step S1002), and sets the same number as the first disk stripe number to the second disk stripe number, which is the next disk stripe number (step S1003). In contrast, if it is determined that the number is larger than the maximum disk number at step S1001, the second calculation unit 702 sets the initial disk number out of the disk numbers of the multiple disk devices to the second disk number, which is the next disk number (step S1004). The second calculation unit 702 sets the number obtained by adding one to the first disk stripe number to the second disk stripe number, which is the next disk stripe number (step S1005).

In the host computer 101 and the disk array control apparatus 700 according to the second embodiment, the host computer 101 calculates the first disk number and the first disk stripe number from the stripe number by division while the disk array control apparatus 700 obtains the second disk number and the second disk stripe number by the method without using division on the basis of the calculated first disk number and first disk stripe number, and the length information. In this way, the calculation using division, which is high load processing, is performed by the host computer 101 while the processing using no division is performed by the disk array control apparatus 700, thereby making it possible to achieve reduction in circuit size of the disk array control apparatus 700. As a result, the circuit size is reduced in the whole of the system.

### Third Embodiment

The following describes a third embodiment.

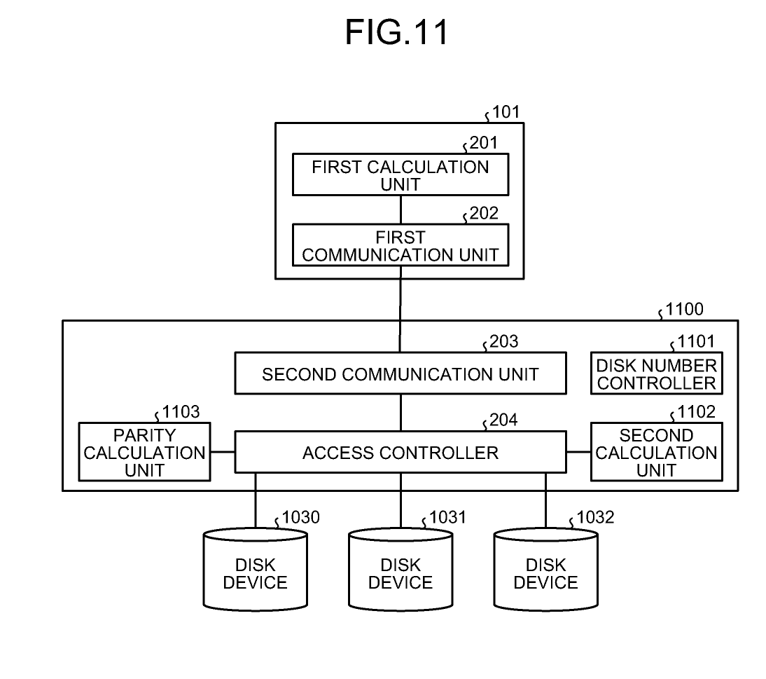

FIG. 11 is a block diagram illustrating a structure of a disk array system according to the third embodiment.

The first calculation unit 201 of the host computer 101 in the third embodiment differs in function from the first calculation unit 201 in the first embodiment.

The first calculation unit 201 performs division on the basis of the stripe number and the number obtained by subtracting one from the number of multiple disk devices to calculate the first disk number and the first disk stripe number. The first calculation unit 201 performs division on the basis of the first disk stripe number and the number of disk devices to calculate a first A disk number on the basis of the remainder of the division. As a result of the calculation of the first A disk number, when the first disk number calculated by the division is equal to the first A disk number or larger than the first disk number, the number obtained by adding one to the first disk number calculated by the division is set to the first disk number.

In the third embodiment, a disk array control apparatus 1100 newly includes a parity calculation unit 1103 in addition to the structure of the disk array control apparatus 700. A disk number controller 1101 and a second calculation unit 1102 differ in function from the disk number controller 701 and the second calculation unit 702, respectively, of the disk array control apparatus 700.

The second communication unit 203 of the disk array control apparatus 1100 receives, from the host computer 101, the first disk number, the first disk stripe number, and the first A disk number.

The parity calculation unit 1103 calculates parity.

The access controller 204 accesses the location identified by the first disk stripe number in the first disk device identified by the first disk number, and writes the parity into the first disk stripe number in a first A disk device identified by the first A device number.

The second calculation unit 1102 calculates the second disk number, the first disk stripe number, and a second A disk number on the basis of the first disk device number, the first disk stripe number, and the first A disk number.

After the access controller 204 accesses the location identified by the first disk stripe number in the first disk device identified by the first disk number and writes the parity into the first disk stripe number in the first A disk device identified by the first A disk number, the disk number controller 1101 performs an update from the first disk number to the second disk number, an update from the first disk stripe number to the second disk stripe number, and an update from the first A disk number to the second A disk number.

After the updates by the disk number controller 1101, the access controller 204 accesses the location identified by the second disk stripe number in the second disk device identified by the second disk number.

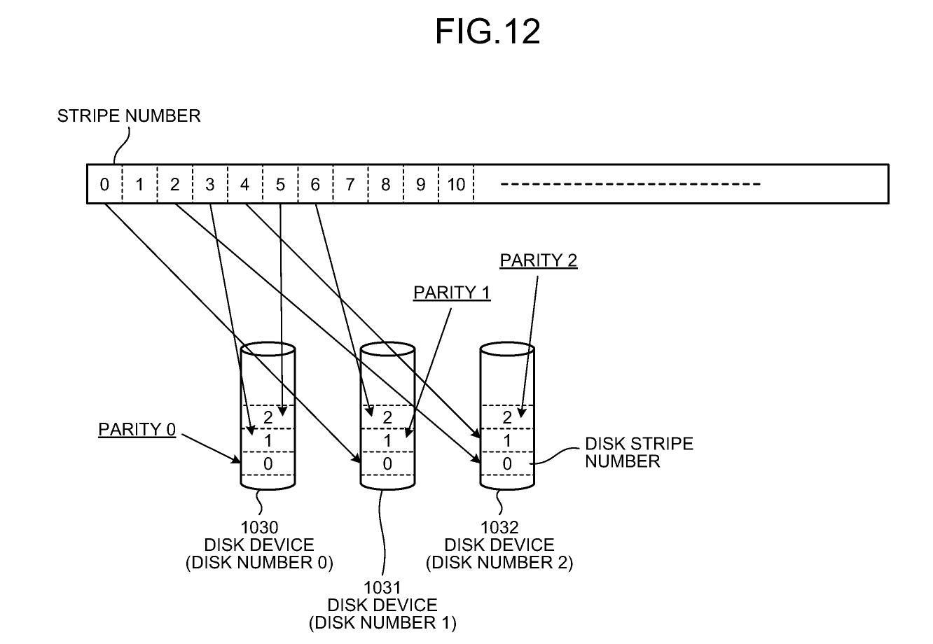

FIG. 12 is a schematic diagram illustrating a relation among the stripe number, the disk number, and the disk stripe number in the third embodiment.

The following describes the specific function of the second calculation unit 1102 with reference to FIG. 12.

When the number obtained by adding one to the first disk number is equal to the first A disk number and the number obtained by adding one to the first A disk number is the available disk number determined by the number of multiple disk devices, the second calculation unit 1102 calculates the number obtained by adding one to the first A disk number as the second disk number, the same number as the first disk stripe number for the second disk stripe number, and the same number as the first A disk number for the second A disk number. The available disk number is determined by the number of disk devices, for example. In the example of FIG. 12, when the first disk number is zero, the first disk stripe number is one, and the first A disk number is one, the second disk number is two, the second A disk number is one, and the second A disk stripe number is one, for example.

When the number obtained by adding one to the first disk number is equal to the first A disk number and the number obtained by adding one to the first A disk number is not the available disk number determined by the number of multiple disk devices, the second calculation unit 1102 calculates the smallest disk number out of the disk numbers of the multiple disk devices as the second A disk number, the number obtained by adding one to the second A disk number as the second disk number, and the number obtained by adding one to the first disk stripe number as the second disk stripe number. In the example of FIG. 12, when the first disk number is one, the first disk stripe number is two, and the first A disk number is two, the second disk number is one, the second A disk number is zero, and the second A disk stripe number is three, for example.

When the number obtained by adding one to the first disk number differs from the first A disk number and is the available disk number determined by the number of multiple disk devices, the second calculation unit 1102 calculates the number obtained by adding one to the first disk number as the second disk number, the same number as the first disk stripe number for the second disk stripe number, and the same number as the first A disk number for the second A disk number. In the example of FIG. 12, when the first disk number is zero, the first disk stripe number is two, and the first A disk number is two, the second disk number is one, the second A disk number is two, and the second A disk stripe number is two, for example.

When the number obtained by adding one to the first disk number differs from the first A disk number and is not the available disk number determined by the number of multiple disk devices, the second calculation unit 1102 calculates the smallest number out of the disk numbers of the multiple disk devices as the second disk number, the number obtained by adding one to the first disk stripe number as the second disk stripe number, and the number obtained by adding one to the first A disk number as the second A disk number. In the example of FIG. 12, when the first disk number is two, the first disk stripe number is zero, and the first A disk number is zero, the second disk number is zero, the second A disk number is one, and the second A disk stripe number is one, for example. In the examples described above, the calculation method of the second disk number, the second disk stripe number, and the second A disk number is described. Until a sum of the lengths from the first disk stripe number to an Nth disk stripe number (N is an integer equal to or larger than 2) is equal to or larger than a length designated by the length information, the second calculation unit 1102 can calculate an (i+1)th disk number (i is an integer between 1 and (N−1), both inclusive), an (i+1)th disk stripe number, and an (i+1)th A disk number in the same manner on the basis of an ith disk number, an ith disk stripe number, and an ith A disk number.

After the access controller 204 accesses a location identified by the ith disk stripe number in an ith disk device, the disk number controller 1101 performs an update from the ith disk number to the (i+1)th disk number, an update from the ith disk stripe number to the (i+1)th disk stripe number, and an update from the ith A disk number to the (i+1)th A disk number.

After the updates by the disk number controller 1101, the access controller 204 accesses a location identified by the (i+1)th disk stripe number in an (i+1)th disk device identified by the (i+1)th disk number.

In the host computer 101 and the disk array control apparatus 1100 according to the third embodiment, the host computer 101 calculates the first disk number, the first disk stripe number, and the first A disk number from the stripe number by division while the disk array control apparatus 1100 obtains the second disk number, the second disk stripe number, and the second A disk number by the method without using division on the basis of the calculated first disk number, first disk stripe number, and first A disk number. In this way, the calculation using division, which is high load processing, is performed by the host computer 101 while the processing using no division is performed by the disk array control apparatus 1100, thereby making it possible to achieve a circuit size reduction in the whole of the system.

### First Modification

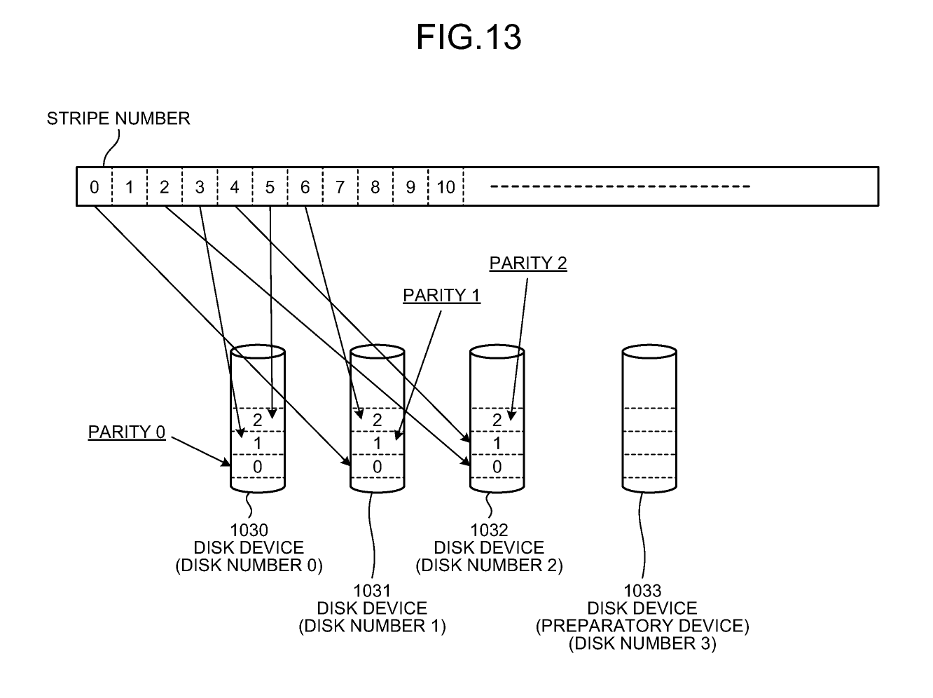

As illustrated in FIG. 13, a system can be assumed that includes a preparatory disk device besides three disk devices, as a first modification of the embodiment.

In this case, the first and the second disk stripe numbers, the first and the second disk numbers, and the first A and the second A disk numbers can be appropriately calculated by the calculation described in the third embodiment excluding the preparatory disk device.

### Second Modification

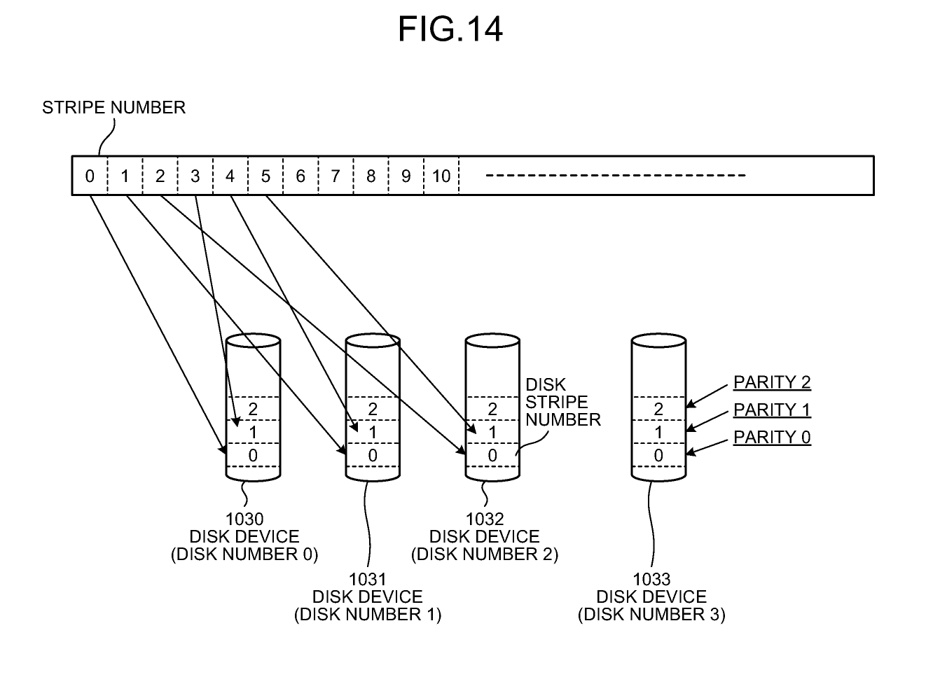

As illustrated in FIG. 14, there is a method in which a disk device is provided separately from three disk devices and parities are stored in only the separated disk device, as a second modification of the embodiment.

In this case, the first and the second disk stripe numbers and the first and the second disk numbers can be appropriately calculated by performing the same calculation as the first or the second embodiment excluding the disk device in which parities are stored. The first A disk number and the second A disk number are fixed values for the device in which parities are stored.

At least one of the embodiments described above has an effect of achieving reduction in circuit size of the storage device control system that includes the storage control apparatus by efficiently sharing roles between the host computer and the storage device control apparatus on processing for identifying the storage device to be accessed and the stripe number in the storage device.

The disk array control apparatus 700 can be achieved using a general-purpose computer as basic hardware, for example. The second communication unit 203, the access controller 204, the disk number controller 701, and the second calculation unit 702 can be achieved by causing a processor mounted in the computer to execute a computer program. In this case, the disk array control apparatus 700 may be achieved by preliminarily installing the program on the computer. Alternatively, the program may be stored on a storage medium, which may be provided as a computer program product, such as a CD-ROM, or may be distributed via a network, and the disk array control apparatus 700 may be achieved by installing the program on the computer as required.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device control apparatus for managing a plurality of storage devices, the storage device control apparatus comprising:
a communication unit configured to receive a first storage device number and a first storage device stripe number, the first storage device number and the first storage device stripe number being obtained by an external host computer from a result of division performed by the external host computer on the basis of a stripe number and the number of storage devices; and
an access controller configured to access a location identified by the first storage device stripe number in a first storage device identified by the first storage device number.

2. The storage device control apparatus according to claim 1, further comprising a calculation unit; and a disk number controller, wherein
the calculation unit is configured to calculate a second storage device number and a second storage device stripe number on the basis of the first storage device number and the first storage device stripe number,
the disk number controller is configured to update the first storage device number to the second storage device number, and the first storage device stripe number to the second storage device stripe number after the access controller accesses the location identified by the first storage device stripe number in the first storage device, and
the access controller accesses a location identified by the second storage device stripe number in a second storage device identified by the second storage device number after the updates by the disk number controller.

3. The storage device control apparatus according to claim 1, further comprising a calculation unit; and a disk number controller, wherein
the communication unit further receives length information from the host computer,
the calculation unit calculates an (i+1)th storage device number and an (i+1)th storage device stripe number on the basis of an ith storage device number and an ith storage device stripe number until a sum of lengths from the first storage device stripe number to an Nth storage device stripe number is equal to or larger than a length designated by the length information, where i is an integer between 1 and (N−1) both inclusive and N is an integer equal to or larger than 2,
the disk number controller updates the ith storage device number to the (i+1)th storage device number, and the ith storage device stripe number to the (i+1)th storage device stripe number after the access controller accesses a location identified by the ith storage device stripe number in an ith storage device identified by the ith storage device number, and
the access controller accesses a location identified by the (i+1)th storage device stripe number in an (i+1)th storage device identified by the (i+1)th storage device number after the updates by the disk number controller.

4. The storage device control apparatus according to claim 2, wherein
the calculation unit calculates a number obtained by adding one to the first storage device number as the second storage device number and a same number as the first storage device stripe number for the second storage device stripe number when the number obtained by adding one to the first storage device number is an available storage device number determined by the number of storage devices, and
the calculation unit calculates a smallest storage device number out of storage device numbers of the storage devices as the second storage device number and a number obtained by adding one to the first storage device stripe number as the second storage device stripe number when the number obtained by adding one to the first storage device number is not an available storage device number.

5. The storage device control apparatus according to claim 1, wherein the communication unit notifies the host computer of the number of storage devices.

6. A storage device control apparatus for managing a plurality of storage devices, comprising:
a communication unit configured to receive a first storage device number and a first storage device stripe number, the first storage number and the first storage device stripe number being obtained by an external host computer from a result of division performed by the external host computer on the basis of a stripe number and a number obtained by subtracting one from the number of storage devices, and receive a first A storage device number obtained by the external host computer from a remainder of division performed by the external host computer on the basis of the first storage device stripe number and the number of storage devices;
a parity calculation unit configured to calculate a parity; and
an access controller configured to access a location identified by the first storage device stripe number in a first storage device identified by the first storage device number, and write the parity into the first storage device stripe number in a first A storage device identified by the first A storage device number.

7. The storage device control apparatus according to claim 6, further comprising a calculation unit; and a disk number controller, wherein
the calculation unit calculates a second storage device number, a second storage device stripe number, and a second A storage device stripe number on the basis of the first storage device number, the first storage device stripe number, and the first A storage device number,
the disk number controller updates the first storage device number to the second storage device number, the first storage device stripe number to the second storage device stripe number, and the first A storage device number to a second A storage device number after the access controller accesses the location identified by the first storage device stripe number in the first storage device and writes the parity into the first storage device stripe number in the first A storage device identified by the first A storage device number, and
the access controller accesses a location identified by the second storage device stripe number in a second storage device identified by the second storage device number after the updates by the disk number controller.

8. The storage device control apparatus according to claim 7, wherein
the calculation unit calculates a number obtained by adding one to the first A storage device number as the second storage device number, a same number as the first storage device stripe number as the second storage device stripe number, and a same number as the first A storage device number as the second A storage device number when a number obtained by adding one to the first storage device number is equal to the first A storage device number and a number obtained by adding one to the first A storage device number is an available storage device number determined by the number of storage devices,
the calculation unit calculates a smallest storage device number out of storage device numbers of the storage devices as the second A storage device number, a number obtained by adding one to the second A storage device number as the second storage device number, and a number obtained by adding one to the first storage device stripe number as the second storage device stripe number when the number obtained by adding one to the first storage device number is equal to the first A storage device number and the number obtained by adding one to the first A storage device number is not an available storage device number determined by the number of storage devices,
the calculation unit calculates the number obtained by adding one to the first storage device number as the second storage device number, the same number as the first storage device stripe number as the second storage device stripe number, and the same number as the first A storage device number as the second A storage device number when the number obtained by adding one to the first storage device number differs from the first A storage device number and is an available storage device number determined by the number of storage devices, and
the calculation unit calculates the smallest storage device number out of the storage device numbers of the storage devices as the second storage device number, the number obtained by adding one to the first storage device stripe number as the second storage device stripe number, and the number obtained by adding one to the first A storage device number as the second A storage device number when the number obtained by adding one to the first storage device number differs from the first A storage device number and is not an available storage device number determined by the number of storage devices.

9. The storage device control apparatus according to claim 6, further comprising a calculation unit; and a disk number controller, wherein
the communication unit further receives length information from the host computer,
the calculation unit calculates an (i+1)th storage device number, an (i+1)th storage device stripe number, and (i+1)th A storage device number on the basis of an ith storage device number, an ith storage device stripe number, and an ith A storage device number until a sum of lengths from the first storage device stripe number to an Nth storage device stripe number is equal to or larger than a length designated by the length information, where i is an integer between 1 and (N−1) both inclusive and N is an integer equal to or larger than 2,
the disk number controller updates the ith storage device number to the (i+1)th storage device number, the ith storage device stripe number to the (i+1)th storage device stripe number, and the ith A storage device number to the (i+1)th A storage device number after the access controller accesses a location identified by the ith storage device stripe number in an ith storage device, and
the access controller accesses a location identified by the (i+1)th storage device stripe number in an (i+1)th storage device identified by the (i+1)th storage device number after the updates by the disk number controller.

10. A storage device control system, comprising:
a host computer;
a storage device control apparatus; and
a plurality of storage devices, wherein
the host computer includes
a first calculation unit configured to obtain a first storage device number and a first storage device stripe number, the first storage device number and the first storage device stripe number being obtained from a result of division performed by the host computer on the basis of a stripe number and the number of storage devices; and
a first communication unit configured to transmit the first storage device number and the first storage device stripe number to the storage device control apparatus, and
the storage device control apparatus includes:
a second communication unit that receives the first storage device number and the first storage device stripe number; and
an access controller configured to access a location identified by the first storage device stripe number in a first storage device identified by the first storage device number.

11. The storage device control system according to claim 10, wherein
the storage device control apparatus further includes a second calculation unit and a disk number controller,
the second calculation unit is configured to calculate a second storage device number and a second storage device stripe number on the basis of the first storage device number and the first storage device stripe number, and
the disk number controller is configured to update the first storage device number to the second storage device number, and the first storage device stripe number to the second storage device stripe number after the access controller accesses the location identified by the first storage device stripe number in the first storage device, and
the access controller accesses a location identified by the second storage device stripe number in a second storage device identified by the second storage device number after the updates by the disk number controller.

12. The storage device control system according to claim 10, wherein
the first communication unit of the host computer further transmits length information to the storage device control apparatus,
the storage device control apparatus further includes a second calculation unit and a disk number controller,
the second communication unit further receives the length information from the host computer,
the second calculation unit is configured to calculate, on the basis of an ith storage device number and an ith storage device stripe number, an (i+1)th storage device number and an (i+1)th storage device stripe number until a sum of lengths from the first storage device stripe number to an Nth storage device stripe number is equal to or larger than a length designated by the length information, where i is an integer between 1 and (N−1) both inclusive, and N is an integer equal to or larger than 2,
the disk number controller updates the ith storage device number to the (i+1)th storage device number, and the ith storage device stripe number to the (i+1)th storage device stripe number after the access controller accesses a location identified by the ith storage device stripe number in an ith storage device identified by the ith storage device number, and
the access controller accesses a location identified by the (i+1)th storage device stripe number in an (i+1)th storage device identified by the (i+1)th storage device number after the updates by the disk number controller.

13. The storage device control system according to claim 11, wherein
the second calculation unit calculates a number obtained by adding one to the first storage device number as the second storage device number, and a same number as the first storage device stripe number as the second storage device stripe number when the number obtained by adding one to the first storage device number is an available storage device number determined by the number of storage devices, and
the second calculation unit calculates a smallest storage device number out of storage device numbers of the storage devices as the second storage device stripe number, and a number obtained by adding one to the first storage device stripe number as the second storage device stripe number when the number obtained by adding one to the first storage device number is not an available storage device number.

14. The storage device control system according to claim 10, wherein the second communication unit notifies the host computer of the number of storage devices.
